(19) United States
(12) Patent Application Publication
(10) Pub. No.: US 2026/0148908 A1
(43) Pub. Date: May 28, 2026

(54) SWITCH DEVICE

(71) Applicant: KABUSHIKI KAISHA TOKAI RIKA DENKI SEISAKUSHO, Aichi (JP)

(72) Inventors: Takao IMAI, Aichi (JP); Masanori FUJII, Aichi (JP); Itaru WATANABE, Aichi (JP); Kazuo DODOMEKI, Aichi (JP); Masayoshi AMANO, Aichi (JP)

(73) Assignee: KABUSHIKI KAISHA TOKAI RIKA DENKI SEISAKUSHO, Aichi (JP)

(21) Appl. No.: 19/177,730

(22) Filed: Apr. 14, 2025

(30) Foreign Application Priority Data
Apr. 22, 2024 (JP) 2024-069113

(51) Int. Cl. H01H 13/14; H01H 13/02

(52) U.S. Cl. CPC H01H 13/14; H01H 13/023

(57) ABSTRACT

A switch device includes an elastically deformable panel, a movable member, a detector, and a sensor sheet. The panel includes an operating portion configured to receive a push-operation and assigned to a corresponding operation function. The movable member is configured to be moved by the push-operation performed on the operating portion. The detector is configured to detect movement of the movable member moved by the push-operation. The sensor sheet is arranged between the panel and the movable member to detect at least one of contact of a human body part with the panel, approach of a human body part toward the panel, and the push-operation performed on the panel. The sensor sheet includes a flexible sheet base configured to be bent and deformed, and an electrode arranged on the sheet base. The electrode is held between the movable member and the sheet base.

### CROSS-REFERENCE TO RELATED APPLICATIONS

This application is based upon and claims the benefit of priority from Japanese Patent Application No. 2024-069113, filed on Apr. 22, 2024, the entire contents of which are incorporated herein by reference.

### BACKGROUND

### 1. Field

The following description relates to a switch device that detects a push-operation performed on a panel.

### 2. Description of Related Art

Japanese Laid-Open Patent Publication No. 2013-134635 discloses a typical operation switch device that detects both a touch-operation and a push-operation. In the operation switch device, a touch detection electrode detects a touch-operation when a user touches an operation region of an operation member of an operation switch unit with a finger. If the operation region is further depressed with the finger, the operation region is moved and changes a state of a push switch located at the depression destination of the operation region. In this case, a push-operation is detected.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

With the above operation switch device, a touch-operation performed on the operation member with a finger is detected by the touch detection electrode arranged on a back surface of the push switch. Therefore, the given distance between the operation member and the touch detection electrode may adversely affect the touch-operation detection sensitivity. In this case, the touch detection electrode may be arranged, for example, on a back surface of the operation member to allow touching of the operation member to be detected using the touch detection electrode arranged near the operation member.

However, the operation member may be formed from an elastic material, such as rubber. Thus, when the operation member is pushed, deformation of the operation member may cause stress or friction on the touch detection electrode. Consequently, wire breakage may occur in the touch detection electrode. In order to prevent such wire breakage of the touch detection electrode, for example, another member may be arranged to protect the touch detection electrode. Nonetheless, arrangement of another member may complicate the structure or increase costs.

In one general aspect, a switch device includes an elastically deformable panel, a movable member, a detector, and a sensor sheet. The panel includes an operating portion configured to receive a push-operation and assigned to a corresponding operation function. The movable member is configured to be moved by the push-operation performed on the operating portion. The detector is configured to detect movement of the movable member moved by the push-operation. The sensor sheet is arranged between the panel and the movable member to detect at least one of contact of a human body part with the panel, approach of a human body part toward the panel, and the push-operation performed on the panel. The sensor sheet includes a flexible sheet base configured to be bent and deformed, and an electrode arranged on the sheet base. The electrode is held between the movable member and the sheet base.

Other features and aspects will be apparent from the following detailed description, the drawings, and the claims.

### BRIEF DESCRIPTION OF THE DRAWINGS

FIG. 1 is a front view of a switch device in accordance with an embodiment.

FIGS. 2A, 2B, and 2C are diagrams illustrating a push-operation performed on a panel.

FIG. 3 is a longitudinal cross-sectional view of the switch device.

FIG. 4 is an enlarged view of part of the longitudinal cross-section of the switch device.

FIG. 5 is a perspective view of a sensor sheet fitted to a casing.

FIG. 6 is a diagram of the sensor sheet in an unfolded state.

FIG. 7 is a cross-sectional view showing the layer structure of the sensor sheet.

FIG. 8A is a diagram of a state before the panel is pushed.

FIG. 8B is a diagram of a state in which the panel is pushed.

FIG. 9 is a diagram showing the electrical configuration of the switch device.

FIG. 10 is a diagram illustrating the operation of the sensor sheet.

FIG. 11 is a perspective view showing a modified example of the sensor sheet.

FIG. 12A is a diagram of a state before the panel is pushed.

FIG. 12B is a diagram of a state in which the panel is pushed.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An embodiment of the present disclosure will now be described.

### Switch Device 1

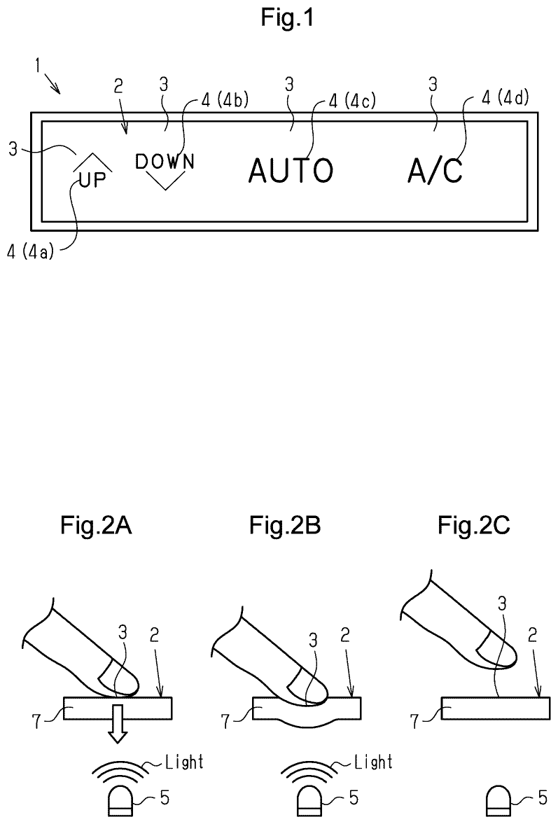

As shown in FIG. 1, a switch device 1 includes a panel 2 that is operated by a user to switch a state of an apparatus, or set a function of the apparatus. The apparatus includes, for example, a vehicle-on-board air conditioner. In the case of the air conditioner, switching of the state of the apparatus (setting of the function of the apparatus) includes, for example, changing of the temperature, switching of the on-off state of an automatic mode, switching of the on-off state of an A/C mode, changing of an air blowing mode, or the like.

The panel 2 includes a front surface on which an operating portion 3 is assigned to a corresponding operation function (apparatus function). That is, the panel 2 includes at least one (in the present example, more than one) operating portion 3. The at least one (in the present example, more than one) operating portion 3 is assigned to a corresponding one of at least one (in the present example, more than one) operation function. In the present example, the front surface of the panel 2 is divided into multiple operating portions 3. The operation function includes, for example, a temperature changing function, an automatic mode on-off function, an A/C mode on-off function, or the like. The operating portion 3 includes, for example, a temperature increasing portion 3, a temperature decreasing portion 3, an automatic mode on/off switching portion 3, an A/C mode on/off switching portion 3, or the like.

As shown in FIGS. 2A to 2C, the panel 2 is a touch panel of a push-in type. The operating portion 3 is configured to be touched by the user with a finger or the like, and pushed by a predetermined amount. Specifically, as shown in FIGS. 2A and 2B, the user may touch a certain operating portion 3 on the panel 2 and push the operating portion 3 by the predetermined amount. This operates the apparatus in accordance with the pushed operating portion 3. As shown in FIG. 2C, when the finger is removed from the operating portion 3 following the push-operation, the panel 2 elastically deforms and returns the operating portion 3 to the original state.

In the present example, for example, a mark 4 is displayed on the panel 2 when a body part of the user touches or approaches the front surface of the panel 2. The mark 4 is provided for each operating portion 3 (refer to FIG. 1). Specifically, when the front surface of the panel 2 is not touched, no mark 4 is displayed on the panel 2. When the front surface of the panel 2 (operating portion 3) is touched, the mark 4 is displayed by a light from a light source 5 arranged at a back-surface side of the panel 2. A touch-operation of the present example includes not only an operation in which the user directly touches the panel 2 with a body part, such as a finger or the like, but also an approach-operation in which, for example, the user holds a hand near the panel 2. The mark 4 includes, for example, a temperature increasing mark 4a, a temperature decreasing mark 4b, an automatic mode operation mark 4c, an A/C mode operation mark 4d, or the like.

### Panel 2

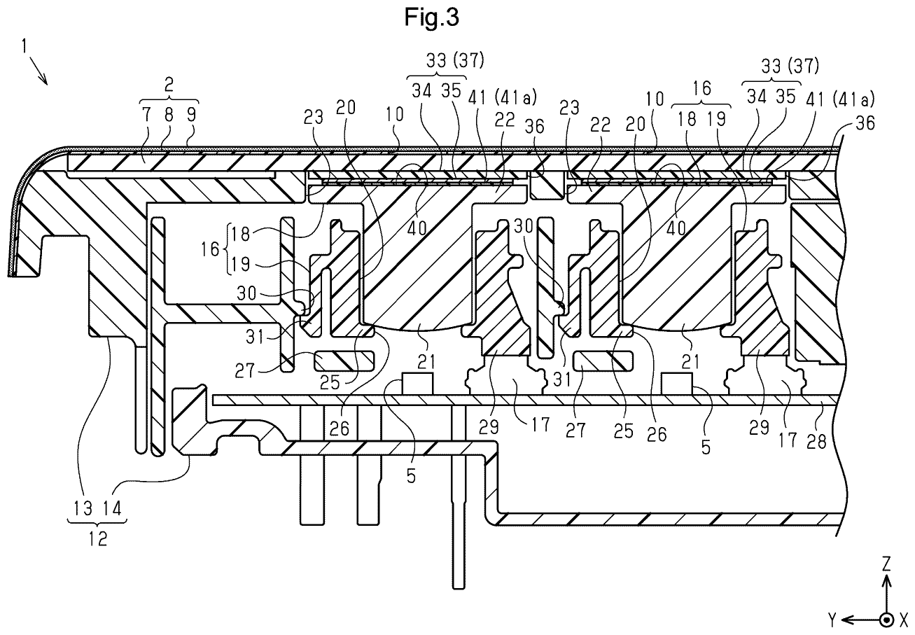

As shown in FIG. 3, the panel 2 is elastically deformable and includes the operating portions 3. The operating portions 3 each receive a push-operation and are respectively assigned to the operation functions. In the present example, the panel 2 includes a panel member 7, an intermediate layer 8, and a protection layer 9. The panel member 7 serves as a main body of the panel 2. The intermediate layer 8 is arranged on an upper surface of the panel member 7. The protection layer 9 is arranged on an upper surface of the intermediate layer 8.

In an example, the panel member 7 is formed from a transparent resin material and has the shape of a flat plate. In the present example, the panel member 7 includes, for example, transparent rubber. The panel member 7 is elastically deformable. For example, when the panel member 7 is pushed by the user with a finger or the like, the panel member 7 is depressed in a pushing direction. When the panel member 7 is released from the pushing, the panel member 7 returns to the original state. In this manner, the flexible panel member 7 may be stretched by an external load.

The intermediate layer 8 is formed from, for example, a light-shielding material that is elastically deformable. The intermediate layer 8 has, for example, an opening 10 shaped in conformance with the mark 4. The intermediate layer 8 covers the entire panel member 7.

The protection layer 9 protects the front surface of the panel 2. The protection layer 9 is formed from, for example, fabric, leather, or the like. The protection layer 9 covers the entire panel member 7 and the entire intermediate layer 8. Preferably, the protection layer 9 is formed from, for example, a light-transmissive material.

### Casing 12

As shown in FIG. 3, the switch device 1 includes a casing 12 that supports the panel 2. The casing 12 includes, for example, a first casing 13 and a second casing 14. The first casing 13 serves as a seat for the panel 2. The second casing 14 closes the first casing 13 from below (side opposite to panel 2). The casing 12 accommodates various components of the switch device 1. That is, the casing 12 has an accommodation compartment defined by the first casing 13 and the second casing 14. Peripheral edges of the intermediate layer 8 and the protection layer 9, which cover the panel member 7, are fixed to corresponding edges of the first casing 13.

### Push-Operation Detection Structure

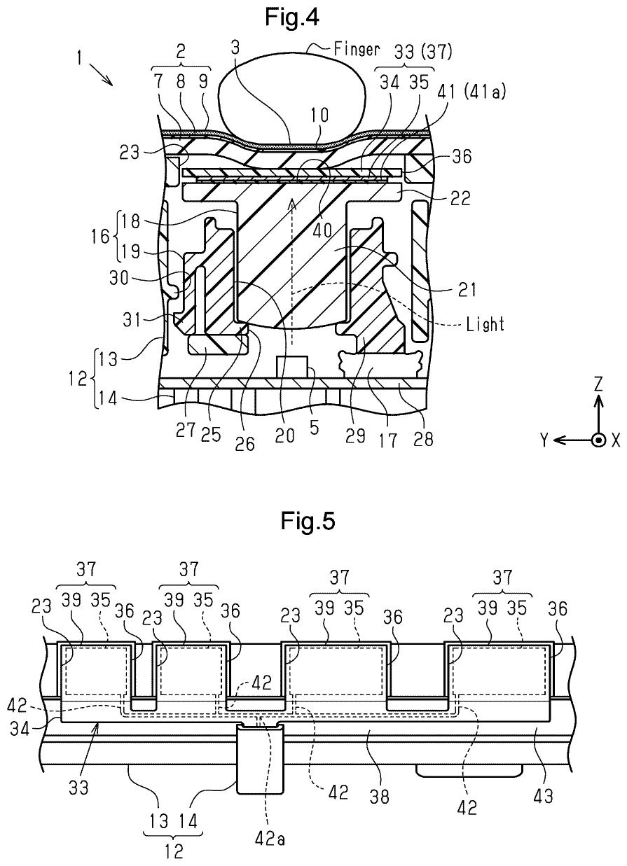

As shown in FIGS. 3 and 4, the switch device 1 includes at least one movable member 16 and a detector 17. The at least one movable member 16 is moved by a push-operation performed on a corresponding operating portion 3. The detector 17 detects the movement of the movable member 16 moved by the push-operation. In the present example, the switch device 1 includes at least one (in the present example, more than one) pair of the movable member 16 and the detector 17. The pair is assigned to a corresponding one of the at least one (in the present example, more than one) operation function. The at least one movable member 16 is moved by a push-operation performed on a corresponding operating portion 3. The at least one detector 17 detects movement of a corresponding movable member 16 moved by a push-operation. The number of pairs of the movable member 16 and the detector 17 is determined in accordance with the number of operating portions 3 (i.e., operation functions) of the panel 2. The movable member 16 is accommodated in the casing 12 in a slidable manner. In the present example, the movable member 16 is accommodated in the casing 12 in a manner allowing for linear reciprocation in a height direction of the casing 12 (Z-axis direction in FIG. 3).

The movable member 16 includes a first part 18 and a second part 19. The first part 18 is moved in a depth direction (negative Z-axis direction in FIG. 3) by a push-operation performed on the operating portion 3 by the user. The second part 19 is coupled to the first part 18. The first part 18 includes a main body 21 and an extension region 22. The main body 21 is arranged in a cavity 20 formed in the second part 19. The extension region 22 is formed on the main body 21 at a position facing the panel member 7. The extension region 22 has a greater area than the main body 21 in a planar direction (X-Y plane direction in FIG. 3). The extension region 22 is arranged in an open portion 23 formed in an upper wall of the casing 12 (in the present example, first casing 13).

The second part 19 includes a support wall 25 and an opening 26. The support wall 25 supports a lower end of the first part 18. The opening 26 exposes a back surface of the first part 18. The support wall 25 extends, for example, about a center of the second part 19 along the entire circumference. In an example, the bottom wall of the cavity 20 of the second part 19 is defined by the opening 26, which is located in the central part of the bottom wall, and the support wall 25, which projects from the side wall of the cavity 20 and extends around the opening 26. The opening 26 is formed about the axis of the second part 19. The casing 12 includes a stopper 27 arranged on an inner wall surface. When the panel 2 is pushed, the stopper 27 comes into contact with the movable member 16 to determine a stroke amount of the movable member 16 in the pushing direction.

The detector 17 uses, for example, a microswitch. The detector 17 is mounted on a substrate 28 that is accommodated in the casing 12. When the panel 2 is pushed and slides the movable member 16 in the pushing direction, a pusher 29 at a distal end of the movable member 16 (second part 19) pushes and turns on the detector 17 (state shown in FIG. 4).

In the present example, the switch device 1 is a momentary switch that stays turned on only while the panel 2 is being pushed by the user. Specifically, when the user pushes the panel 2 and slides the movable member 16 in the pushing direction against a biasing force of a biasing member (not shown), the detector 17 stays turned on only while the detector 17 is being pushed by the movable member 16.

When the finger is removed from the panel 2, the biasing force of the biasing member (not shown) slides the movable member 16 away from the detector 17 in an opposite-pushing direction (positive Z-axis direction in FIG. 3) and returns the detector 17 to the original off state (state shown in FIG. 3). The movable member 16 (second part 19) includes an engagement piece 31 arranged on a side surface. When the movable member 16 is moved in the opposite-pushing direction, the engagement piece 31 engages a protrusion 30 arranged on an inner surface of the casing 12 so that the position of the movable member 16 is determined.

### Sensor Sheet 33

As shown in FIGS. 3 and 4, the switch device 1 includes a sensor sheet 33 that detects at least one of contact of a human body part with the panel 2, approach of a human body part toward the panel 2, and a push-operation performed on the panel 2 (operating portion 3). The sensor sheet 33 is arranged between the panel member 7 and the at least one (in the present example, more than one) movable member 16. In the present example, the sensor sheet 33 is arranged between a back surface of the panel member 7 and the extension region 22 of each movable member 16.

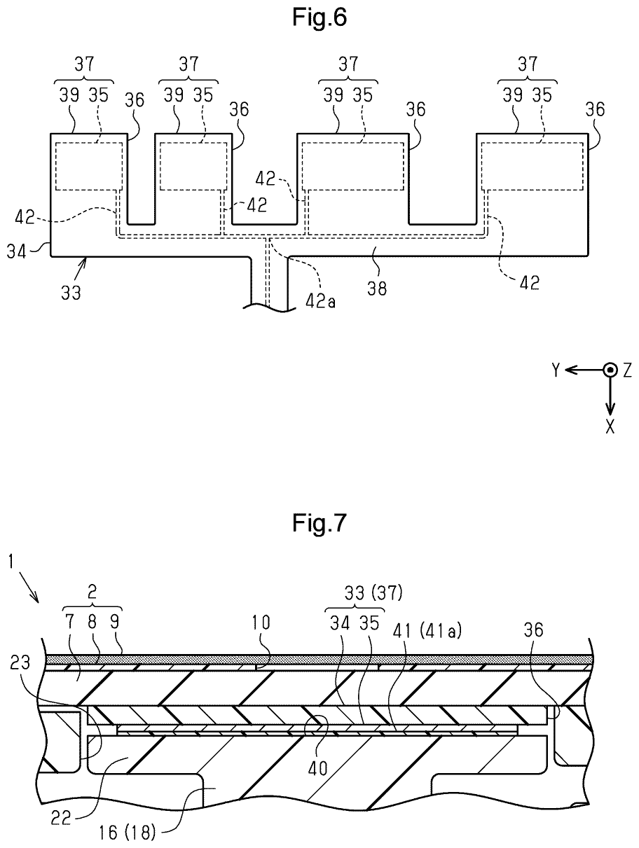

As shown in FIGS. 5 and 6, the sensor sheet 33 includes a sheet base 34 and electrodes 35. The sheet base 34 is configured to be bent and deformed. The electrodes 35 are arranged on the sheet base 34 in correspondence with the operating portions 3. The sheet base 34 includes a gap 36 formed between adjacent ones of the electrodes 35. The gap 36 is formed by, for example, a slit. The gaps 36 may differ in length as in the present example. Alternatively, the length may be identical. In the present example, the sensor sheet 33 has a comb-tooth pattern in which the gaps 36 are arranged next to one another and open in the same side of the sensor sheet 33. The sheet base 34 is formed from, for example, transparent resin.

The sensor sheet 33 includes a plurality of electrode placement portions 37 and a connecting portion 38. Each of the electrode placement portions 37 is arranged between adjacent ones of the gaps 36 and includes a corresponding one of the electrodes 35. The connecting portion 38 connects the electrode placement portions 37. Each electrode placement portion 37 includes a base segment 39 and the electrode 35 arranged on the base segment 39. The base segment 39 defines the shape of the electrode placement portion 37 in the sheet base 34. In the present example, the electrode 35 is arranged on part of the base segment 39, specifically, a position located toward a distal end of the base segment 39.

As shown in FIGS. 3 and 4, the electrode placement portions 37 are at least partially arranged on a basal end surface 40 of each movable member 16 so as to face the panel 2, which has the shape of a flat plate. (In the present example, the electrode placement portions 37 are partially arranged on the basal end surface 40 of each movable member 16.) In the present example, the basal end surface 40 is an upper end surface of the extension region 22 of the first part 18. The electrode placement portions 37 are arranged so that each of the electrode placement portions 37 is paired with a corresponding one of the operating portions 3 (movable members 16). In other words, the electrodes 35 are respectively provided for the operating portions 3. In the present example, the sensor sheet 33 includes the electrodes 35 respectively assigned to the operating portions 3. Each electrode placement portion 37 is located between the back face of the panel member 7 and the upper end face of the extension region 22 of a corresponding first part 18.

As shown in FIG. 5, the connecting portion 38 is at least partially bent in a direction intersecting the basal end surface 40 of the movable member 16 (Z-axis direction in FIGS. 3 and 4) and is at least partially arranged at a side of the movable members 16. In the present example, the connecting portion 38 and a basal end part of each electrode placement portion 37 are located at the side of the movable members 16.

### Electrode 35

As shown in FIGS. 5 and 6, each electrode 35 is layered on the sheet base 34. The electrode 35 is, for example, a transparent electrode that is light-transmissive. Examples of the electrode 35 include a vapor-deposition layer formed by vaporizing an electrode material to form a film on the sheet base 34, a printed portion formed by printing an electrode material on the sheet base 34, or the like. That is, the electrode 35 is, for example, an indium tin oxide (ITO) film, a transparent ink, or the like.

As shown in FIG. 7, the electrode 35 is held between the movable member 16 and the sheet base 34. In the present example, the electrode 35 is arranged on a back surface of the sheet base 34 and is located between the back surface of the sheet base 34 and the first part 18 of the movable member 16.

The sensor sheet 33 is arranged on both the panel 2 and the movable member 16 without a gap. In the present example, the sensor sheet 33 is in direct contact with the panel 2. Further, in the present example, the sensor sheet 33 is arranged so that there is no gap between the electrode 35 and the movable member 16. The electrode 35 may be in direct contact with the movable member 16. Alternatively, another member may be arranged between the electrode 35 and the movable member 16.

A position fixer 41 is arranged between the movable member 16 and the electrode 35. The position fixer 41 fixes the position of the electrode 35 relative to the movable member 16. In the present example, the position fixer 41 is, for example, an adhesion layer 41a. The adhesion layer 41a is, for example, a transparent double-sided tape or the like. The sensor sheet 33 is fixed to the basal end surface 40 of the movable member 16 by the adhesion layer 41a. A front surface of the electrode 35 is fixed to the back surface of the sheet base 34, and a back surface of the electrode 35 is fixed to the movable member 16. When the position fixer 41 is the adhesion layer 41a, the electrode 35 is arranged on the movable member 16 via the adhesion layer 41a without a gap. The position fixer 41 (adhesion layer 41a) is not arranged between the panel 2 and the sensor sheet 33.

As shown in FIG. 6, each electrode 35 includes a wiring part 42 electrically connected to the substrate 28. In the present example, the wiring part 42 is at least partially arranged in the connecting portion 38 (in the present example, both in electrode placement portion 37 and connecting portion 38). The wiring parts 42 of the electrodes 35 are connected into a single wiring line at a joint point 42a. The wiring parts 42 of at least two electrodes 35 may be connected. The wiring parts 42 of the electrode 35 do not necessarily have to be connected.

### Layout of Connecting Portion 38 of Sensor Sheet 33

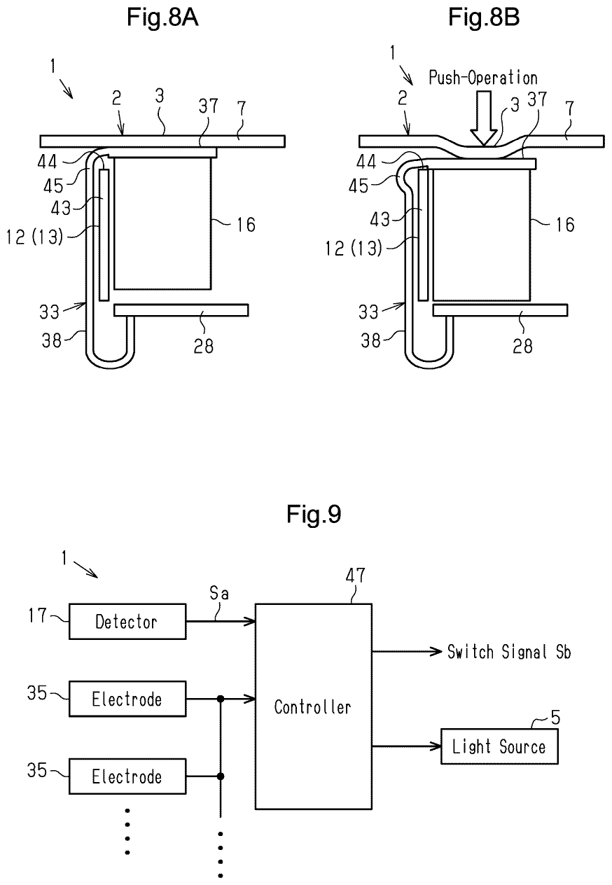

As shown in FIGS. 8A and 8B, at least the connecting portion 38 (in the present example, connecting portion 38 and part of each electrode placement portion 37) is arranged along an outer surface of a wall 43 of the casing 12. In the present example, the basal end of each electrode placement portion 37 extends out of a clearance 44 between the back surface of the panel member 7 and an upper end surface of the wall 43. Further, the connecting portion 38 and the basal end of the electrode placement portion 37 are arranged along the outer surface of the wall 43 such that a distal end of the connecting portion 38 reaches the substrate 28.

### Bent Portion 45

As shown in FIGS. 8A and 8B, the sensor sheet 33 includes a bent portion 45 that bends and deforms when the movable member 16 is moved by pushing of the panel 2. The bent portion 45 is arranged at a part of the sensor sheet 33 (sheet base 34) extending out of the clearance 44.

### Illumination of Switch Device 1

As shown in FIGS. 3 and 4, the switch device 1 includes the light source 5 that displays the mark 4, which corresponds to the operating portion 3, on the panel 2 through illumination. For example, the light source 5 is a light-emitting diode (LED) and is mounted on the substrate 28. The light source 5 is arranged at a back-surface side of the panel 2. The light source 5 is, for example, positioned directly below the movable member 16 (first part 18). The light source 5 emits a light through the opening 10 of the intermediate layer 8 to the outside. This displays the shape of the opening 10 on the panel 2 as the mark 4.

In the present example, the movable member 16 is formed from, for example, resin. In particular, it is preferred that the movable member 16 (specifically, first part 18) acts as a light guide that guides the light from the light source 5 toward the mark 4. The light guide includes, for example, a transparent material, such as glass, plastic, acrylic, or the like. It is preferred that the movable member 16 (specifically, first part 18) is formed from a light-transmissive material.

### Electrical Configuration of Switch Device 1

As shown in FIG. 9, the switch device 1 includes a controller 47 that controls operation of the switch device 1. The controller 47 includes, for example, a central processing unit (CPU), an electronic control unit (ECU), or the like. The detector 17 and the electrodes 35 are connected to an input to the controller 47. That is, the controller 47 receives a detection signal Sa from the detector 17 and the capacitance from each electrode 35. The movable member 16 is movable between an initial position at which the extension region 22 is located in the open portion 23 and a pushed position at which the detector 17 is pushed by the pusher 29. When the detector 17 is turned on, the controller 47 receives from the detector 17 a detection signal Sa indicating that the detector 17 is turned on. Based on the received detection signal Sa, the controller 47 determines that the movable member 16 is located at the pushed position, or that a push-operation is performed. Although multiple electrodes 35 are shown in FIG. 9, there may be only a single electrode 35. The light source 5 is connected to an output of the controller 47.

The controller 47 detects pushing of the operating portion 3 of the panel 2 based on the detection signal Sa received from the detector 17, and then outputs a switch signal Sb to another ECU or the like. The controller 47 detects contact of a human body part with the panel 2 or approach of a human body part toward the panel 2 based on a change in the capacitance of the electrode 35. In the present example, when the controller 47 detects that a human body part came into contact with the panel 2 or approached toward the panel 2 based on a change in the capacitance of the electrode 35, the controller 47 illuminates the mark 4 on the panel 2 by lighting the light source 5. This allows the user to immediately recognize the corresponding relationship of the operation function and the operating portion 3 on the panel 2.

### Operation of the Present Embodiment

The operation of the switch device 1 in accordance with the present embodiment will now be described.

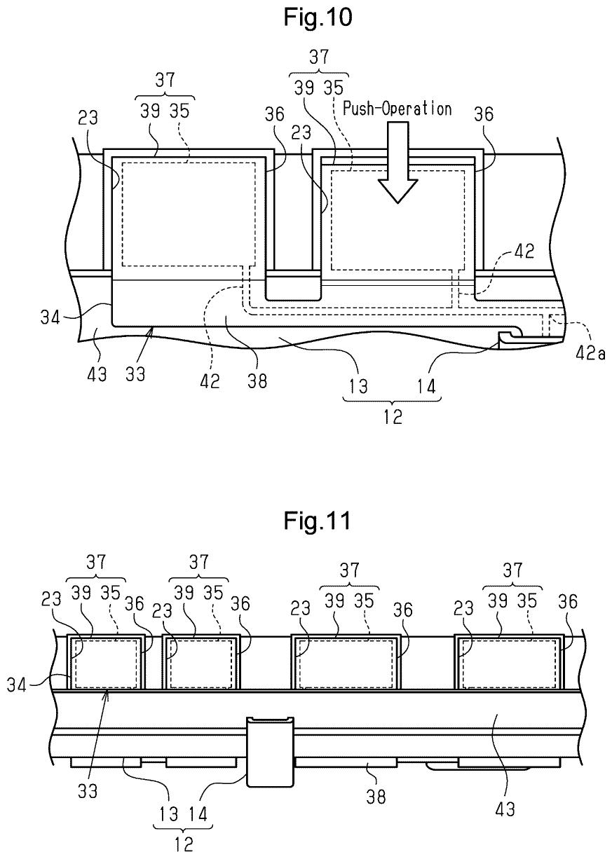

As shown in FIG. 10, the sensor sheet 33 includes the gap 36 formed between adjacent ones of the electrodes 35. This allows each electrode placement portion 37 to deform independently in accordance with the corresponding electrode 35. Therefore, when a predetermined operating portion 3 of the panel 2 is pushed, only the electrode placement portion 37 of the sensor sheet 33 located directly below the pushed operating portion 3 is moved downward. In other words, the entire sensor sheet 33 will not be depressed around the pushed point of the operating portion 3. This minimizes the stretching load applied to the sensor sheet 33, thereby avoiding breakage of the sensor sheet 33.

As shown in FIGS. 3 and 4, in the switch device 1 of the present example, the sensor sheet 33 is arranged on the back surface of the panel 2. If the sensor sheet 33 is fixed on the back surface of the panel 2, when the user pushes the panel 2, the electrode 35 of the sensor sheet 33 deforms together with the panel 2 and may have wire breakage. In particular, the transparent electrode 35 formed by a vapor-deposition layer or the like is vulnerable to stress, such as folding or bending. A separate component may be arranged as a protection member so as to prevent such wire breakage of the electrode 35. However, arrangement of a separate component may complicate the structure or increase costs.

In the present example, the electrode 35 is arranged on the back surface of the sheet base 34 and is fixed between the movable member 16 and the sheet base 34. Accordingly, when the panel 2 is pushed, the sensor sheet 33 moves in the pushing direction together with the movable member 16 in a state in which the electrode 35 is held between the sensor sheet 33 and the movable member 16. Therefore, even when the panel 2 is elastically deformed by the pushing, the sensor sheet 33 maintains in the same shape state without being affected by the elastic stretching of the panel 2. This minimizes the stretching load applied to the electrode 35 by the panel 2, thereby avoiding breakage of the electrode 35.

In addition, the movable member 16 acts as a light guide, so that the number of components of the switch device 1 can be reduced. This may also reduce component costs and facilitate coupling of the components. Furthermore, the above structure allows the components to be arranged such that there will be no layer of air between the sensor sheet 33 and the light guide (movable member 16). This improves transmissivity of the light from the light source.

### Advantages of the Embodiment

The switch device 1 of the above embodiment has the following advantages.
(1) The switch device 1 includes the elastically deformable panel 2, at least one movable member 16, the detector 17, and the sensor sheet 33. The panel 2 includes the operating portion 3 configured to receive a push-operation. The movable member 16 is configured to be moved by the push-operation performed on the panel 2. The detector 17 is configured to detect the movement of the movable member 16. The sensor sheet 33 detects at least one of contact of a human body part with the panel 2, approach of a human body part toward the panel 2, and a push-operation performed on the panel 2 (operating portion 3). The sensor sheet 33 includes the flexible sheet base 34 and the electrode 35. The sheet base 34 is configured to be bent and deformed. The electrode 35 is arranged on the sheet base 34. The electrode 35 is held between the movable member 16 and the sheet base 34.

With this structure, the electrode 35 is fixed between the movable member 16 and the sheet base 34. Therefore, even when the panel 2 is pushed and the elastic deformation of the panel 2 moves the movable member 16 and the sensor sheet 33 in the pushing direction, the electrode 35 is not deformed in correspondence with the panel 2. In this manner, even though no separate member is added, the load by the elastic deformation of the pushed panel 2 will not be transmitted to the electrode 35 as a deformation load. This protects the electrode 35 from breakage with a relatively simple structure.
(2) The electrode 35 is provided for each operating portion 3. With this structure, the electrodes 35 are respectively provided for the operating portions 3. This ensures touch-operation detection.
(3) The position fixer 41 is arranged between the movable member 16 and the electrode 35 to fix the position of the electrode 35 relative to the movable member 16. With this structure, the position fixer 41 maintains a state in which the electrode 35 is sandwiched between the movable member 16 and the sheet base 34. This further avoids breakage of the electrode 35.
(4) The sensor sheet 33 is arranged on both the panel 2 and the movable member 16 without a gap. With this structure, the panel 2 and the sensor sheet 33 are arranged without any gap in between. That is, these components are arranged close to each other. This improves the touch-operation detection sensitivity. Further, the sensor sheet 33 (electrode 35) and the movable member 16 are arranged without any gap in between. This improves light transmissivity.
(5) The switch device 1 includes the light source 5 that displays the mark 4, which corresponds to the operating portion 3, on the panel 2 through illumination. With this structure, the mark 4 allows for visual recognition of the operation function corresponding to the operating portion 3. This improves operation convenience for the user.
(6) The movable member 16 acts as a light guide that guides the light from the light source 5 toward the panel 2. With this structure, the movable member 16 also acts as a light guide. This reduces the number of components as compared with when the light guide is a separate component.
(7) The wiring parts 42 of the electrodes 35 are electrically connected to each other into a single wiring line. Accordingly, even if a plurality of relatively small electrodes 35 is provided for each movable member 16, the electrodes 35 can be used as one electrode 35 having a relatively large area. This improves the detection sensitivity of the electrode 35.

### Other Embodiments

The above embodiment may be modified as follows. The above embodiment and the following modifications can be combined as long as they remain technically consistent with each other.

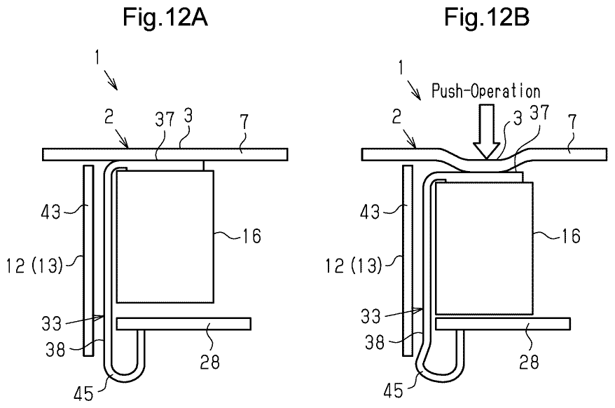

As shown in FIGS. 11, 12A, and 12B, when there is a predetermined gap between the wall 43 of the casing 12 (refer to FIG. 12) and the movable member 16, the sensor sheet 33 (specifically, connecting portion 38) may be partially arranged in this gap. This utilizes the gap between the wall 43 of the casing 12 and the movable member 16 effectively. Further, as shown in FIGS. 12A and 12B, the bent portion 45 may be formed at a part extending out from the lower end of the wall 43.

The gaps 36 do not have to be arranged next to one another and open in the same side of the sheet base 34. Alternatively, the gaps 36 may be alternately arranged and open in the two opposite sides of the sheet base 34.

The electrode placement portions 37 do not have to be located only at positions corresponding to the movable members 16. For example, the electrode placement portions 37 may also be arranged at positions corresponding to the gaps 36. This increases the electrode area, thereby further improving the touch-operation detection sensitivity.

The sensor sheet 33 may be formed as a single sheet with no gap 36. In this case, the electrodes 35 may be arranged on the sheet base 34, which does not include the gaps 36, at positions corresponding to the operating portions 3. Alternatively, in this case, the sheet base 34 may include only one electrode 35.

When the gaps 36 are omitted from the sensor sheet 33, there may be only one electrode 35 having a size that corresponds to the sheet base 34, which does not include the gaps 36.

The position fixer 41 is not limited to a double-sided tape and may be, for example, an adhesive.

The position fixer 41 is not limited to the adhesion layer 41a. For example, the position fixer 41 may position the electrode 35 relative to the movable member 16 through engagement of a projection arranged on the movable member 16 and a hole in the electrode 35 (sensor sheet 33).

When the panel 2 is not pushed, there may be no gap between the panel 2 (panel member 7) and the sensor sheet 33. Alternatively, there may be a gap between the panel 2 (panel member 7) and the sensor sheet 33.

The panel 2 does not have to cover the plurality of movable members 16. For example, the panel 2 may be provided for each movable member 16.

The material of the panel 2 may include a polyethylene terephthalate (PET) sheet or silicon.

The movable member 16 does not have to include multiple parts and may be formed by a single part.

The wiring parts 42 may be connected to one another at any position. Alternatively, the wiring parts 42 do not have to be connected.

Each electrode placement portion 37 may be entirely arranged on the basal end surface 40 of the movable member 16.

The connecting portion 38 may be partially arranged on the basal end surface 40 of the movable member 16.

The connecting portion 38 does not have to be bent perpendicularly with respect to the electrode placement portion 37. Instead, the connecting portion 38 may be bent at an angle other than a right angle. For example, the connecting portion 38 may be bent diagonally with respect to the electrode placement portion 37.

The sheet base 34 does not have to be shaped as shown in the above embodiment.

The intermediate layer 8 having the shape in conformance with the mark 4 may be arranged on the back surface of the panel member 7.

The mark 4 may be displayed on the panel 2 as an image or a video using liquid crystals.

The mark 4 may be always visually recognizable. For example, the mark 4 may be illuminated with the light of the light source 5 at night.

The light guide may be a member differing from the movable member 16.

The intermediate layer 8 and/or the protection layer 9 may be omitted from the panel 2.

The detector 17 does not have to be a mechanical switch and may be a sensor.

The momentary structure of the switch device 1 does not have to use a biasing force of a spring to return to the initial position, and may use, for example, an elastic force of rubber or the like.

The sensor sheet 33 does not have to include the electrodes 35 arrayed in a single row. The electrodes 35 may be arrayed in two or more rows.

The number of electrodes 35 does not have to be two or more, and may be one.

The apparatus operated by the switch device 1 is not limited to an air conditioner, and may be, for example, a car navigation device, an audio device, a lighting device, or the like.

The present disclosure described in accordance with embodiments is to be considered as illustrative and not restrictive. The present disclosure includes various modified examples and modifications within the scope of equivalence. Additionally, various combinations and modes and one, more, or less of these elements in other combinations and forms are included in the range and conceptual scope of the present disclosure.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A switch device, comprising:
an elastically deformable panel including an operating portion, the operating portion being configured to receive a push-operation and assigned to a corresponding operation function;
a movable member configured to be moved by the push-operation performed on the operating portion;
a detector configured to detect movement of the movable member moved by the push-operation; and
a sensor sheet arranged between the panel and the movable member to detect at least one of contact of a human body part with the panel, approach of a human body part toward the panel, and the push-operation performed on the panel, wherein:
the sensor sheet includes a flexible sheet base configured to be bent and deformed, and an electrode arranged on the sheet base; and
the electrode is held between the movable member and the sheet base.

2. The switch device according to claim 1, wherein
the operating portion is one of multiple operating portions, and
the electrode is one of multiple electrodes respectively provided for the multiple operating portions.

3. The switch device according to claim 1, wherein a position fixer is arranged between the movable member and the electrode to fix a position of the electrode relative to the movable member.

4. The switch device according to claim 1, wherein the sensor sheet is arranged on both the panel and the movable member without a gap.

5. The switch device according to claim 1, further comprising a light source that displays a mark on the panel through illumination, the mark corresponding to the operating portion.

6. The switch device according to claim 5, wherein the movable member acts as a light guide that guides a light from the light source toward the panel.
